(19) United States
(12) Patent Application Publication
(10) Pub. No.: US 2024/0198551 A1
(43) Pub. Date: Jun. 20, 2024

(54) BAG OPENING DEVICE

(71) Applicant: AGRO BAG A/S, Bjaeverskov (DK)

(72) Inventor: Mads BIRKEDAL, Valby (DK)

(21) Appl. No.: 18/286,556

(22) PCT Filed: Apr. 5, 2022
(86) PCT No.: PCT/IB2022/000171

§ 371 Date: Oct. 12, 2023

(30) Foreign Application Priority Data
Apr. 28, 2021 (PL) P.437722

(51) Int. Cl. B26D 1/03; B65B 69/00

(52) U.S. Cl. CPC B26D 1/03; B65B 69/0041

(57) ABSTRACT

The subject of invention is a device (1) for opening bags, in particular bags containing loose materials, consisting of sharp-pointed elements (6) mounted in at least one row and fixed on at least one profile (5), characterized in that the sharp-pointed elements (6) are shaped like an arrowhead and the ends of at least one profile (5) are in which they are embedded are attached to the perimeter of the lower frame (2) of the device (1), with a movable frame (3) placed above the lower frame (2), movably connected to the lower frame (2) by means of pins placed at the corners of the frames (2, 3) and a locking mechanism (4), and containing at least one profile (7) with a hole adapted to the dimensions of the sharp-pointed elements (6) and positioned over the profile (5) with the sharp-pointed elements (6), the device (1) further comprises handles (9) attached to the lower frame (2).

The subject of the invention is a device for opening bags, in particular big-bags or other bags containing loose materials.

Bag cutting devices, especially used in agriculture, are known in the art. The blades of the devices known in the art are oriented around the central axis, with the part of the blades at the central axis having a greater height, which makes the shape of the entire cutting unit close to a cone.

Utility model W.128345 is known the essence of which is a self-adjusting big-bag cutter characterized by the fact that it has a set of blades crowning the profiled walls set together with the longest sides and the lower sides fixed in the base, while the profile walls have vertical slots in which an elastic element is set and above the set of blades a spring-hinged casing segment is set, having an arrangement of external slots with a shape corresponding to the outline of the set of blades, with the casing segment having in its upper part internal partitions with through holes. The elastic element is a clamp situated in vertical slots. The cover section has an umbrella-like outline on the outer surface.

European Patent EP2853499 (B1) discloses a device for opening bags, in particular bags containing materials for agriculture and industry. The device comprises a central axis oriented in a vertical direction, the upper part of which comprises at least one end adapted for piercing the bag. The device further comprises at least one blade adapted for cutting off the bag and is attached to the lower part of the central axis, the blade or each blade having a sharp edge oriented towards the upper part of the central axis, characterized in that the device further comprises immobilizing means for immobilization of the free part of each blade opposite to the lower part of the central axis.

Since these bags tilted uncontrollably when placed on various cutters known from the prior art, especially when placed on the blades with a cone-like structure, known from the prior art, it has become necessary to develop a device for cutting bag, which device would open the bags in a safe and stable manner and their contents would spill out to the intended place.

The essence of the invention is a device for opening bags, in particular bags containing loose materials, consisting of sharp-pointed elements mounted in at least one row and fixed on at least one profile, characterized in that
the sharp-pointed elements are in the shape of an arrowhead and the ends of at least one profile on which they are mounted are attached to the perimeter of the lower frame of the device, with a movable frame located above the lower frame, movably connected to the lower frame by pins placed at the frame corners and a mechanism locking and comprising at least one profile with an hole adapted in size to the dimensions of the sharp-pointed elements and positioned over the profile with the sharp-pointed elements, furthermore the device comprises handles attached to the lower frame.

Preferably, at least one foldable blocking member of the movable frame is mounted on at least one side of the lower frame.

The moveable frame comprises reinforcing ribs between its sides and at least one profile with a hole.

Preferably, the lower frame comprises support elements located at its corners.

Optionally, the pins are ended on one side with a spherical swelling or a joint.

Preferably, the device comprises a bumper mounted on the lower frame.

The bumper is optionally in the form of a vertical section which is attached to the lower frame on one side and includes a bracket on the other side.

The bumper folds at the height of the movable frame.

The bumper comprises a damping element in the form of a rubber element or at least one spring.

Preferably, the locking mechanism is in the form of at least two springs.

Optionally, the device comprises four springs disposed between the lower frame and the movable frame at their corners.

Preferably, the pins connecting the lower frame with the movable frame are located inside the springs arranged at the corners of the frames.

Preferably, the device has two rows of sharp-pointed elements, the rows optionally being arranged at right angles to each other.

The sharp-pointed elements have a different spearhead angle, preferably elements with a larger spearhead angle and a smaller spearhead angle being arranged alternately in a row.

The sharp-pointed elements are detachably mounted on the profile.

The sharp-pointed elements are mounted on the profile movably in relation to the fixing part.

The sharp-pointed elements are made of steel.

The lower frame and the movable frame are preferably square-shaped.

Preferably, the device comprises a support mechanism enabling the device to be mounted on a container or semi-trailer.

The support mechanism of the device comprises two opposing handles connected by struts with holes slidably positioned in toothed racks, and the handles comprise profiled handle connectors with the struts, which connectors comprise pin-locked holes.

The device according to the invention enables safe opening of various types of bags containing loose materials. It is used especially in the agricultural industry. The construction of the device according to the invention in the form of two flat frames, between which there is a locking mechanism, allows for stable positioning of the bag to be unpacked without its unfavourable sideways movements. The weight of the bag presses the movable frame against the lower frame and through this movement the sharp-pointed elements are ejected through the hole in the profile located in the movable frame, which allows the bag to be torn apart.

Thanks to the use of a locking mechanism, preferably based on springs, the sharp-pointed elements, in the initial position, are located between the lower frame and the movable frame, which protects their uncontrolled sliding out and accidental injury to the person operating the device, the mechanism blocks the sharp-pointed elements against accidental pressure. The force of the springs used in the device according to the invention blocks it against accidental pressure. Depending on the type of springs, they can be compressed under pressure with a weight, e.g. not less than 60 kg, which makes it impossible to slide out the sharp-pointed element with less pressure. If it is necessary to open bags with, for example, less weight, it is possible to use springs with a different pressure force.

The device according to the invention can additionally use at least one folding blocking member located on the lower frame, which, after unfolding, additionally blocks the movable frame against its uncontrolled lowering and simultaneous slide out of the sharp-pointed elements. The foldable blocking member is unfolded when the device is not used, and it is not possible to lower the movable frame and cut the bags.

The folding blocking member may be in the form of two parts movable relative to each other, one of which supports the movable frame, while the other part in turn supports the first part preventing its uncontrolled folding.

The lower frame is connected with the movable frame by means of a mechanism based on pins ended with a ball or a joint. The given pin is located inside the spring.

The movable frame may further comprise reinforcing ribs permanently fixed between at least one profile and the sides of the frame, this enables additional reinforcement of the structure when using the device according to the invention for opening bags of heavy weight.

In the device according to the invention, a bumper can be applied which additionally stabilizes the bag placed on the device and limits its movement, e.g. outside the movable frame, and also significantly facilitates the positioning of the bag in relation to sharp-pointed elements. The bumper in the place of attachment to the lower frame may have a shock absorber in the form of an elastic element, e.g. a spring or a rubber element. In addition, the bumper folds in such a way that its upper part is placed on the movable frame, which additionally protects against uncontrolled sliding of sharp-pointed elements when the device is not used.

The geometry of the pointed elements and their different sizes allow the bag to be cut open over a larger area than with such prior art devices and therefore the bags can be emptied faster and more efficiently. In an optional variant of the invention, the sharp-pointed elements can be connected to the profile in a movable manner relative to the fixing part. The sharp-pointed elements can be made of steel or they can also be stainless with a higher corrosion resistance.

The support mechanism can be used when it is necessary to pour the contents of the bags onto a trailer, for example. This mechanism makes it possible to adjust both the spacing of the handles and to lower the device according to the invention by changing the position of the pins. Such adjustment of the length of the support mechanism allows the device to be adapted to different spacing of trailers, regardless of the manufacturer and model, which makes the device according to the invention universal. The handles of the supporting mechanism may differ in the shape of the bend and may be used interchangeably depending on the size and shape of the edge of the container/trailer.

On the other hand, the possibility of lowering the device according to the invention by changing the position of the pins on the handle, allows for the potential covering of the device on the trailer with a tarpaulin.

An object according to the invention is illustrated in the figure, wherein the respective figures represent:

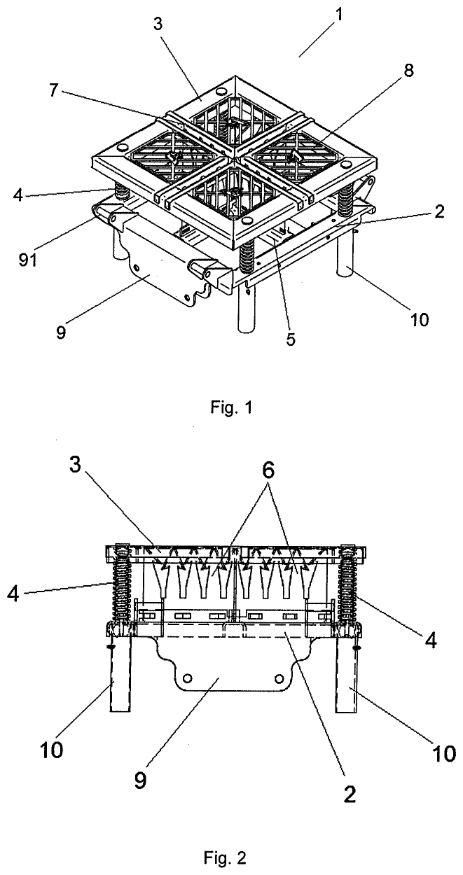

FIG. 1 Device according to the invention;

FIG. 2 Cross-section of the device according to the invention;

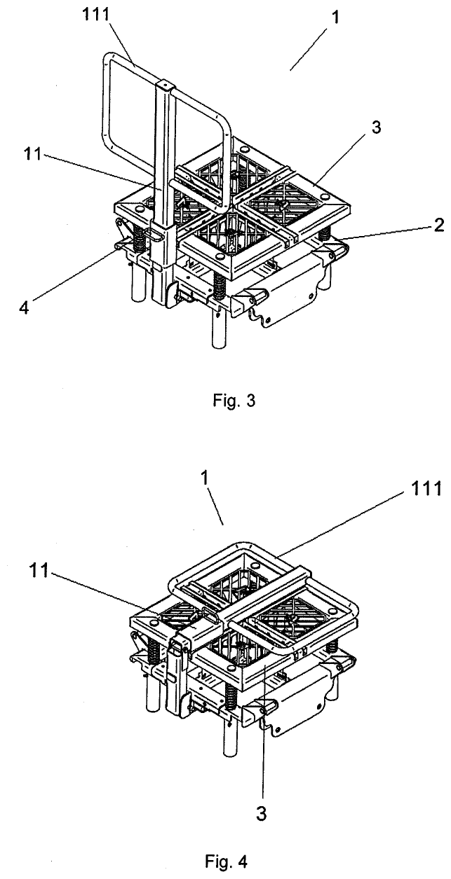

FIG. 3 Device according to the invention with a bumper;

FIG. 4 Device according to the invention with a folded bumper;

FIG. 5 Device according to the invention with a support mechanism;

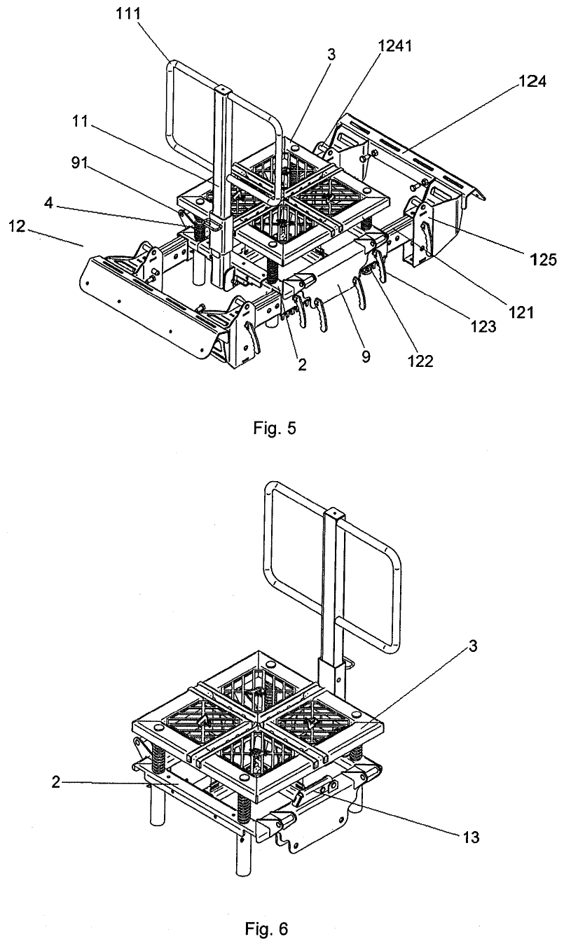

FIG. 6 Device according to the invention with a folding blocking member in the folded form;

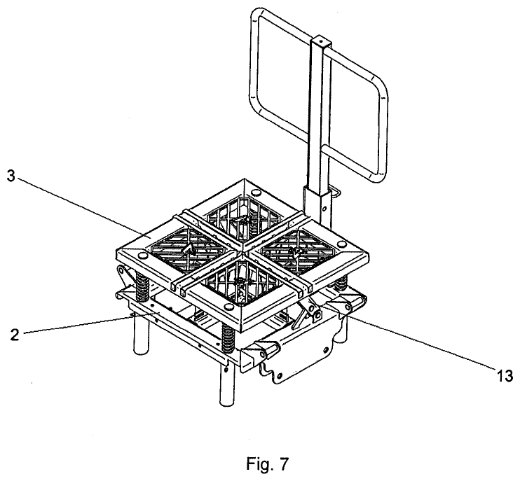

FIG. 7 Device according to the invention with a folding blocking member in the unfolded form.

FIG. 1 shows a device 1 according to the invention which consists of two square-shaped frames parallel to each other: a lower frame 2 and a movable frame 3 connected by pins placed in the corners of the frames. A locking mechanism is mounted between the lower frame 2 and the movable frame 3, which in the embodiment of the device according to the invention is in the form of four springs 4 placed at the corners of the frames 2, 3. The pins between the frames (not shown) are located inside the springs 4. Two profiles 5 are fastened perpendicularly to each other on the lower frame 2 in such a way that their ends are fixed on the circumference of the lower frame 2, which is also shown in FIG. 2.

The profiles 5 have sharp-pointed elements 6 (shown in FIG. 2) in the shape of an arrowhead, the elements being arranged alternately—with a larger arrowhead angle and a smaller arrowhead angle. On the movable frame 3, profiles are mounted with holes 7 adjusted to the dimensions of pointed elements 6 and placed over the profiles 5 with sharp-pointed elements 6. Between the profiles with holes 7 and the perimeter of the mobile frame 3, reinforcing ribs 8 are fixed.

On the lower frame 3, on opposite sides, handles 9 are mounted, enabling the device according to the invention to be mounted on size-adapted containers or to be mounted on a support mechanism. On the underside of the lower frame 3, support members 10 are attached.

FIG. 3 shows an example of a device 1 according to the invention in which a bumper 11 is mounted on the lower frame 2. The bumper is in the form of a section which at one end is attached to the lower frame 2 while the other end comprises a bracket 111. The bracket 111 in the illustrated embodiment is in the form of a rectangular profile. In another embodiment, the longer sides of the support 111 may be bent towards the device according to the invention—this facilitates the stabilization of the bag to be opened at the height of the frames of the device 1. The height of the bumper 11 is adjusted in such a way that when it is folded, the bracket 111 is on the movable frame 3. The buffer 11 may comprise a damping element in the form of a rubber element or a spring.

The bumper, at the height of the movable frame, folds, and after folding—as shown in FIG. 4—its upper part is placed on the movable frame 3, which additionally secures against uncontrolled pressure on the movable frame 3 and the protrusion of sharp-pointed elements 6 when the device does not is used.

FIG. 5 shows a device according to the invention with a support mechanism 12. The support mechanism 12 comprises struts 121 with holes for length adjustment which struts 121 are slidably positioned in the toothed rack 122. The connection of the struts 121 and the toothed rack 122 as well as the length adjustment is possible by means of pins 123.

The toothed racks 122 make it possible to adjust the length of the support mechanism 12 depending on the width of the container on which the device according to the invention is to be placed. The struts 121 are connected to the handles 124 of the support mechanism 12. The handles 124 comprise profiled connectors 125 of the handle 124 with struts 121, which connectors include pin-lockable holes which allow the height of the struts 121 on which the device of the invention is mounted to be adjusted.

Both the handles 9 of the device according to the invention and the handles 124 of the support mechanism can comprise hooks (91; 1241) to facilitate mounting the device according to the invention to the container by means of ropes or chains.

FIGS. 6 and 7 show an embodiment of the invention in the form of a bag-opening device with a folding blocking member 13 attached to the lower frame 2. FIG. 6 shows the situation in which the folding blocking member 13 is in a closed form and the operation of the device according to the invention is possible, while FIG. 7 shows a situation in which the foldable locking element 13 is unfolded and one of its parts blocks the movement of the movable frame 3.

1. A device (1) for opening bags, in particular bags containing loose materials, consisting of sharp-pointed elements (6) mounted in at least one row and fixed on at least one profile (5), characterized in that the sharp-pointed elements (6) are shaped like an arrowhead and the ends of at least one profile (5) are in which they are embedded are attached to the perimeter of the lower frame (2) of the device (1), with a movable frame (3) placed above the lower frame (2), movably connected to the lower frame (2) by means of pins placed at the corners of the frames (2, 3) and a locking mechanism (4), and containing at least one profile (7) with a hole adapted to the dimensions of the sharp-pointed elements (6) and positioned over the profile (5) with the sharp-pointed elements (6), the device (1) further comprises handles (9) attached to the lower frame (2).

2. Device according to claim 1 characterized in that at least one foldable blocking member (13) of the movable frame (3) is mounted on at least one side of the lower frame (2).

3. Device according to claim 1, characterized in that the movable frame (3) comprises reinforcing ribs (8) between its sides and at least one profile (7) with a hole.

4. Device according to claim 1, characterized in that the lower frame (2) comprises support members (10) positioned at its corners.

5. Device according to claim 1, characterized in that the pins are ended on one side with a spherical swelling or a joint.

6. Device according to claim 1, characterized in that it comprises a bumper (11) fixed to the lower frame (2).

7. Device according to claim 1, characterized in that the bumper (11) is optionally in the form of a vertical section which is attached to the lower frame (2) on one side and includes a bracket (111) on the other side.

8. Device according to claim 1, characterized in that the bumper (11) folds at the height of the movable frame (3).

9. Device according to claim 1, characterized in that the bumper (11) comprises a damping element in the form of a rubber element or at least one spring.

10. Device according to claim 1, characterized in that the locking mechanism (4) is in the form of at least two springs.

11. Device according to claim 1, characterized in that it comprises four springs arranged between the lower frame (2) and the movable frame (4), at their corners.

12. Device according to claim 1, characterized in that the pins connecting the lower frame (2) to the movable frame (3) are located inside springs arranged at the corners of the frames.

13. Device according to claim 1, characterized in that the device has two rows of sharp-pointed elements (6), the rows being at right angles to each other.

14. Device according to claim 1, characterized in that the sharp-pointed elements (6) have a different tip angle.

15. Device according to claim 1, characterized in that sharp-pointed elements (6) with a larger arrowhead angle and pointed elements with a smaller arrowhead angle are arranged alternately in a row.

16. Device according to claim 1, characterized in that the sharp-pointed elements (6) are detachably mounted on the profile.

17. Device according to claim 1, characterized in that the sharp-pointed elements (6) are mounted on the profile movably in relation to the fixing part.

18. Device according to claim 1, characterized in that the sharp-pointed elements (6) are made of steel.

19. Device according to claim 1, characterized in that the lower frame (2) and the movable frame (3) are preferably square-shaped.

20. Device according to claim 1, characterized in that the device comprises a support mechanism (12) enabling the device to be mounted on a container, semi-trailer.

21. Device according to claim 20, characterized in that the support mechanism (12) of the device comprises two opposing handles connected by struts (121) with holes slidably positioned in toothed racks (122), and the handles comprise profiled handles connectors with the struts, which connectors comprise pin-locked holes.
